(19) United States
(12) Patent Application Publication
(10) Pub. No.: US 2012/0146565 A1
(43) Pub. Date: Jun. 14, 2012

(54) DEVICE AND METHOD FOR DRIVING AN ELECTRIC MACHINE FOR ABATING AND MASKING DISTINCTIVE ACOUSTIC EMISSIONS

(75) Inventor: Riccardo Parenti, Pieve Ligure (IT)

(73) Assignee: ANSALDO ENERGIA S.P.A., Genova (IT)

(21) Appl. No.: 13/319,729

(22) PCT Filed: May 11, 2010
(86) PCT No.: PCT/IB10/01079

§ 371 Date: Feb. 29, 2012

(30) Foreign Application Priority Data
May 11, 2009 (IT) TO2009A 000370

(51) Int. Cl. H02P 27/08

(52) U.S. Cl. 318/503

(57) ABSTRACT

A device for driving an electric motor includes: an inverter circuit, configured for converting a d.c. supply signal into an a.c. supply signal; and a control block, connected to the inverter circuit and configured for controlling the inverter circuit by means of a pulse-width modulation, having a given cycle-period value. The driving device further includes a first random-number generator, connected to the control block and configured for supplying to the control block pseudo-random or random cycle-period values.

### TECHNICAL FIELD

The present invention relates to a device and a method for driving an electric machine, in particular for favoring abatement and masking of the acoustic emissions in axial-flux permanent-magnet electric motors.

### BACKGROUND ART

As is known, electric motors can be classified, on the basis of the type of supply, in d.c. (direct current) motors and a.c. (alternate current) motors. In particular, a.c. motors can in turn be divided into synchronous motors and asynchronous motors. Both synchronous and asynchronous electric motors are generally of the three-phase type and can be interfaced to a d.c. supply network by means of voltage converters or inverters, which are designed to make a conversion from a d.c. voltage present on an input to an a.c. voltage at output. In general, the a.c. voltage at output must be regulated both in amplitude and in frequency. It is possible to use converters implemented by means of switches (for example, diodes, transistors, thyristors, IGBTs, etc.), turning on and turning off of which is controlled so as to carry out the desired conversion. For example, it is possible to use an inverter controlled by means of a pulse-amplitude modulation (PAM) or a pulse-width modulation (PWM) with impressed voltage or current.

FIG. 1 shows a portion of a generic inverter circuit 1, of a known type, supplied with a supply voltage V_{AL}, of a d.c. type. The inverter circuit 1 comprises first, second, and third inverter sections 2a, 2b and 2c, each designed to generate a respective phase a, b, c of operation of the a.c. electric motor. Each inverter section 2a, 2b, 2c includes two switches 3, for example transistors, connected in series to one another, and two diodes 4, each of which is connected in parallel to a respective switch 3. A known control method of the inverter circuit 1 envisages that each switch 3 is opened (turned on) or closed (turned off) on the basis of a digital signal according to a pulse-width modulation (PWM), for generating at output a control signal of the electric motor, having a voltage pattern such as to generate in the load a sinusoidal or pseudo-sinusoidal pattern of the current at a desired fundamental frequency.

FIG. 2a shows a digital signal 6, generated using a pulse-width modulation, which can be used for open and close the switches 3 belonging to one and the same inverter section 2a and/or 2b and/or 2c of FIG. 1, obtaining a voltage on the load such as to generate current patterns in the phases of the motor that approximate a reference signal 7, which is quasi sinusoidal, of the type illustrated in FIG. 2b. The reference signal 7 represents an ideal a.c. current signal for supply of the electric motor, for one of the three phases a, b, c.

According to the logic value (“1” or “0”) assumed by the digital signal 6, the switches 3 are controlled so as to generate on the load (i.e., on the windings of the electric motor, ideally of an inductive type) a current signal 8 such as to approximate the reference signal 7 locally. For example, during a positive semiperiod of the digital signal 6, the value of the current signal 8 increases, whilst during a negative semiperiod of the digital signal 6, the switching signal 8 decreases. To guarantee proper operation of the electric motor, it is expedient for the current signal 8 to be comprised in a guard interval δ, centred on the reference signal 7 and defined by an upper guard signal 9 and by a lower guard signal 10.

Inverter circuits, for example of the type described with reference to FIG. 1, can be used in a plurality of applications, for example in control systems for high-power electric motors, more in detail for axial-flux permanent-magnet (AFPM) motors, both for propulsion and drive motors. In AFPM motors, the control of the current in the phases of the motor is obtained, for example, by means of current regulators in synchronous reference with the rotor, and the switches 3 of the inverter circuit 1 are controlled by means of PWM to obtain the desired voltage impression, for example as described with reference to FIGS. 2a and 2b.

In greater detail, in high-power electric motors (for example, higher than 150 kW), the energy necessary for creation of the required torque is generated by controlling, in the previously described way, the current that circulates in the windings of the motor itself so as to obtain a global evolution of the current that is typically slow, of the same order of magnitude as the mechanical rotation frequency of the motor multiplied by the number of poles of the machine (for example, in the range from 0 to 300 Hz). For this purpose, there are added repeated high-frequency voltage pulses (for example, in the range from 3 to 50 kHz), generated by the repeated sequence of turning on and off (as has been said, in PWM modulation) of the switches of the inverter that connects the motor to the supply.

Even though the PWM technique enables control of considerable electrical powers with negligible energy losses, it generates, however, a high background noise with an important energy peak precisely at the switching frequency of the switches. Hence, inverters of the type described generate both acoustic and electromagnetic disturbance.

In particular, the electromagnetic disturbance flows towards the load, towards the supply network through the input stage of the inverter, and towards the surrounding environment through the cables for connection to the motor, in the form of radio disturbance, potentially incompatible with national or international directives on electromagnetic compatibility (EMC).

From an acoustic standpoint, instead, PWM-controlled voltage-inverter circuits of the type described are usually a cause of significant noise at frequencies audible for the human ear (at times recognizable as a “whistle”). At times an attempt is made to overcome this problem by increasing the switching frequency beyond the limits of additive capacity of the human ear. Even though said switching frequencies are not in the audible range, they can generate problems of various nature, also linked to health, due to the high energy emission (a 200-kW inverter that emits only 0.5% of energy in said form, emits in effect approximately 1 kW of ultrasound energy). Since said frequencies are moreover frequently comprised in the VLF or LF radiofrequency bands, they may be a cause of undesirable interference with various measurement or tracking systems.

Furthermore, the current signal 8 effectively obtained is, in the frequency domain, rich in harmonics at frequencies different from the fundamental frequency, whereas the sinusoidal wave that should ideally be obtained is without harmonics. This leads to a lower efficiency of the equipment supplied due to the significant energy dissipation at the frequency of the aforesaid harmonics both in terms of heat and in terms of acoustic energy, as well as in terms of electromagnetic energy.

### DISCLOSURE OF INVENTION

The aim of the present invention is to provide a device and a method for driving an electric machine which overcomes the drawbacks of the prior art.

According to the present invention are provided a device and a method for driving an electric machine, as defined respectively in claims 1 and 14.

### BRIEF DESCRIPTION OF THE DRAWINGS

For a better understanding of the present invention, a preferred embodiment is now described, purely by way of non-limiting example, with reference to the attached drawings, wherein:

FIG. 1 shows a portion of an inverter circuit of a known type designed to provide a supply current/voltage of three-phase type;

FIG. 2a shows a signal, which is of a known type and is modulated according to a pulse-width modulation (PWM), for controlling one among the three phases of the inverter circuit of FIG. 1, and which may refer to the control of the impressed voltage;

FIG. 2b shows a triangular current signal, of a known type, provided to an ideally inductive load by the inverter of FIG. 1, operated by means of a voltage impression in conformance with the signal of FIG. 2a, for one a the three phases, and which may refer to the evolution of the current in the load;

FIG. 3 shows a block diagram of a device for driving an electrical apparatus according to the present invention;

FIG. 4 shows a block diagram of a random-number generator that can be used in the driving device of FIG. 3 according to one embodiment;

FIG. 5 shows a circuit diagram of a circuit for generating a noise signal with characteristics similar to a noise of a white type in a limited range of frequencies of interest, which can be used in the random-number generator of FIG. 4;

FIG. 6 shows a statistical distribution that illustrates the frequency with which samples of the noise signal generated by the noise-signal generator circuit of FIG. 5 is obtained following upon sampling;

FIG. 7 shows a look-up table that can be used for modifying the statistical distribution of FIG. 6;

FIG. 8 shows a statistical distribution transformed following upon application of the look-up table of FIG. 7 to the statistical distribution of FIG. 6; and

FIG. 9 shows a block diagram of a random-number generator that can be used in the driving device of FIG. 3 according to a further embodiment.

### BEST MODE FOR CARRYING OUT THE INVENTION

According to one embodiment of the present invention, the switching frequency of the switches of the inverter is varied in a random or pseudo-random way. In this way, the parasitic switching energy, which can have considerable acoustic effect, can be dispersed on a wider frequency band, reducing the sound components at an audible frequency and/or ultrasound components, thus changing sensibly the acoustic impression of the motor and rendering it, as a whole, difficult to perceive or recognize.

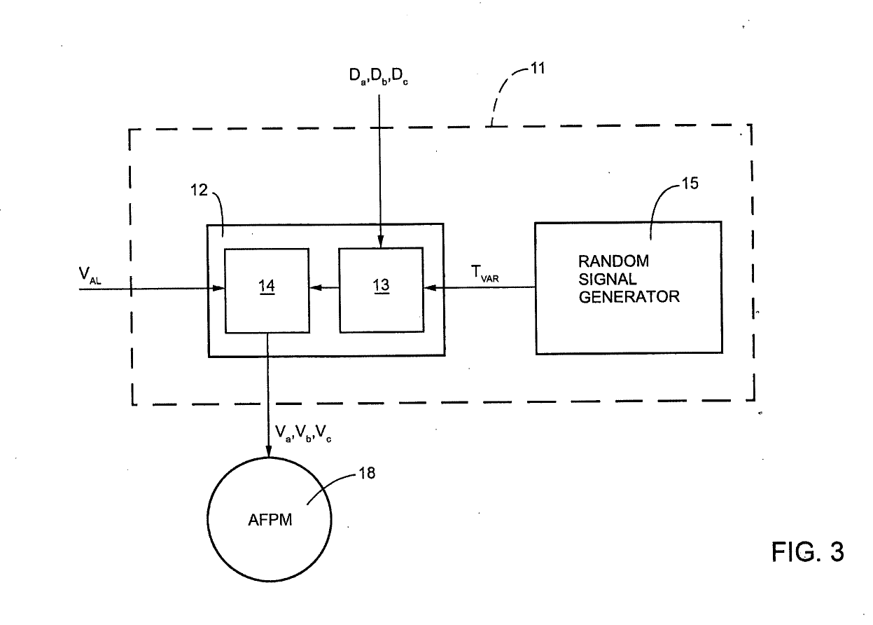

FIG. 3 shows a driving device 11 usable for regulation of the speed in multiphase electric machines, for example three-phase electric motors of a synchronous type, in particular of an axial-flux permanent-magnet (AFPM) type.

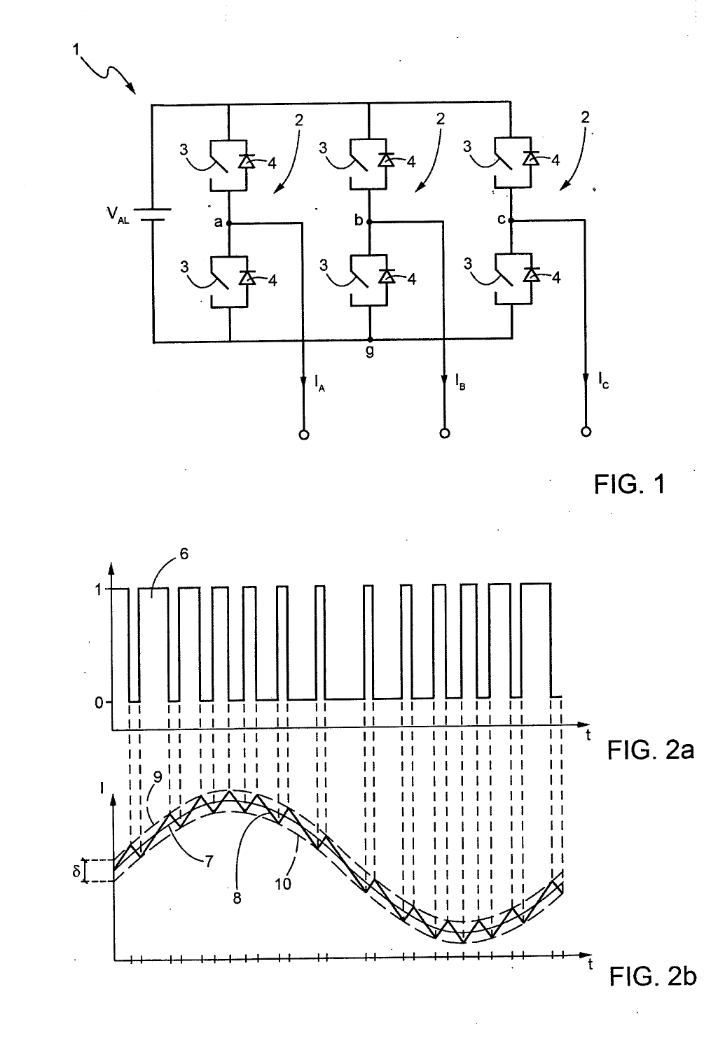

The driving device 11 comprises an inverter device 12, of a known type, and a random-signal generator 15, connected to the inverter device 12. In greater detail, the inverter device 12 includes a control block 13 and an inverter circuit 14, for example comprising the portion of inverter circuit 1 of FIG. 1, which are connected to one another. The control block 13 is generally of a software type, for example configured for controlling, according to a pulse-width modulation, the switches of the inverter circuit 14, whilst the inverter circuit 14 comprises the power electronics of the inverter device 12. In this way, as described with reference to FIGS. 1, 2a and 2b, an alternating current for operation of an electric motor 18 is generated starting from a supply voltage V_{AL}, received at input to the inverter circuit 14.

With reference to a three-phase electric motor 18, the control block 13 receives at input from a duty-cycle computation block (of a known type, not illustrated) duty-cycle control parameters Da, Db, Dc, each of them defining, for a respective phase a, b, c, the ratio between the “on” times and “off” times of the switches 3 of the inverter circuit 14, irrespective of the duration of the period of the control signal for turning-on/turning-off the switches 3 themselves. For example, given, for each phase a, b, c, respective periods Tₐ, T_{b}, T_{c} of PWM cycle, the respective semiperiods T_{a′, T}_{b′, T}_{c′ and T}_{a″, T}_{b″, T}_{c″ (for example, semiperiod of high logic signal and semiperiod of low logic signal, respectively) which form the periods T}ₐ, T_{b}, T_{c} are given by: Tₐ′=Da·T and T_{a″=T-Da·T for phase a; T}_{b}′=Db·T and T_{b}′=T−Db·T for phase b; T_{c}′=Dc·T and T_{c}″=T−Dc·T for phase c.

In this case, the control block 13 turns on and off respective switches of the inverter circuit 14 with semiperiods of on/off states equal to T₁′ and T₁″.

The inverter circuit 14 then supplies at output a.c. voltage components Va, Vb, Vc, for each of the three phases a, b, c, so as to generate in the windings of the electric motor 18 a set of three currents Ia, Ib, Ic desired for operation of the electric motor 18 itself (see also FIG. 1).

The random-signal generator 15 is connected to the control block 13 for supplying at input to the control block 13 a period value T_{VAR}, which represents the duration of the cycle period of the PWM for feedback control in on-state of the switches 3 of the inverter circuit 14. The control block 13, on the basis of the period value T_{VAR} received from the random-signal generator 15 and of the duty-cycle control parameters Da, Db, Dc, turns on and off the switches of the inverter circuit 14.

From the standpoint of the mechanic-propulsive action of the electric motor 18, it is important to respect, cycle by cycle, the ratio between the on times and the off times (i.e., the duty cycle), whereas it is of no importance, generically and within a set of values depending upon the electrical characteristics of the motor and of the control circuit, the effective duration of the entire period, provided that during each semiperiod, the switches 3 are controlled so as to respect a guard interval δ (as illustrated in FIG. 2b), which depends upon the characteristics of the electric motor 18, so that the current supplied will not overstep guard values of proper operation.

Hence, by varying the period value T_{VAR} with constant duty-cycle in a random or pseudo-random way, it is possible to regulate in a random or pseudo-random way the switching frequency of the switches of the inverter circuit 14 without any adverse effects on the continuity of rotation and generation of torque supplied by the electric motor 18.

The present applicant has verified that, to vary in complete safety (for example, preventing any interruptions of service on account of activation of the overcurrent protection) the period value T_{VAR} during operation of the electric motor 18, it is convenient for the duration of a current period and the duration of an immediately subsequent period to have a certain contiguity of value. Merely by way of example, it would be possible to impose, by means of a software program, that the variation of duration between an N-th period and an (N+1)-th period be contained within an interval of ±5% (or any other percentage value that may be deemed useful given the characteristics of the motor and of the inverter used) of the duration of the N-th period.

In use, the random-signal generator 15 supplies at predetermined instants, for example at each switching cycle or else every K switching cycle (with K inductively comprised between 2 and 10), to the control block 13 the period value T_{VAR} that must be used. In turn, the control block 13 stores the duration of the supplied period value T_{VAR} and uses it, with possible processing operations that take into account the aforesaid convenience of contiguity, for driving the switches of the inverter circuit 14, as has already been described. In general, the period value T_{VAR} for the (N+1)-th period is supplied to the control block 13 during the N-th period.

According to a first embodiment, the random-signal generator 15 includes a software pseudo-noise random generator (PNRG), of a known type, configured to generate pseudo-random numbers having an own statistical distribution, for generating a period value T_{VAR}, for example, at each PWM cycle. The statistical distribution of the random-signal generator 15 can be of various types, for example linear or gaussian or of some other type, according to the design choices and to the specific application (for example, it might be desired to avoid completely or render far from likely some values of the control period for governing the inverter for reasons linked to the physical construction of the inverter itself).

However, since a generator of this type cannot guarantee the aforesaid contiguity between the value of the N-th cycle and the value of the next, (N+1)-th, cycle, it is possible to set generically, via software, a value of maximum variation between values generated in succession. For example, as has been said, it is possible to limit the value generated at the (N+1)-th cycle within a range of values comprised between −5% and +5% of the value at the N-th cycle. Alternatively, it is possible not to limit the period value T_{VAR} but configure the control block 13 in such a way that, upon receipt of the period value T_{VAR}, the control block 13 increments/decrements at each cycle the duration of the period with which it controls the inverter circuit 14 until the period value T_{VAR} required is reached, safeguarding the operation in safety, without any stoppages, of the electric motor 18.

However, a software generator of random or pseudo-random numbers, albeit guaranteeing a good lack of correlation between values generated in succession on restricted time intervals, does not guarantee a total lack of correlation of the sequence of the values generated if the sequence is observed over a sufficiently wide time interval, where, on the contrary, in general an explicit repetition or qualitative analogy between the sequences of values generated is highlighted.

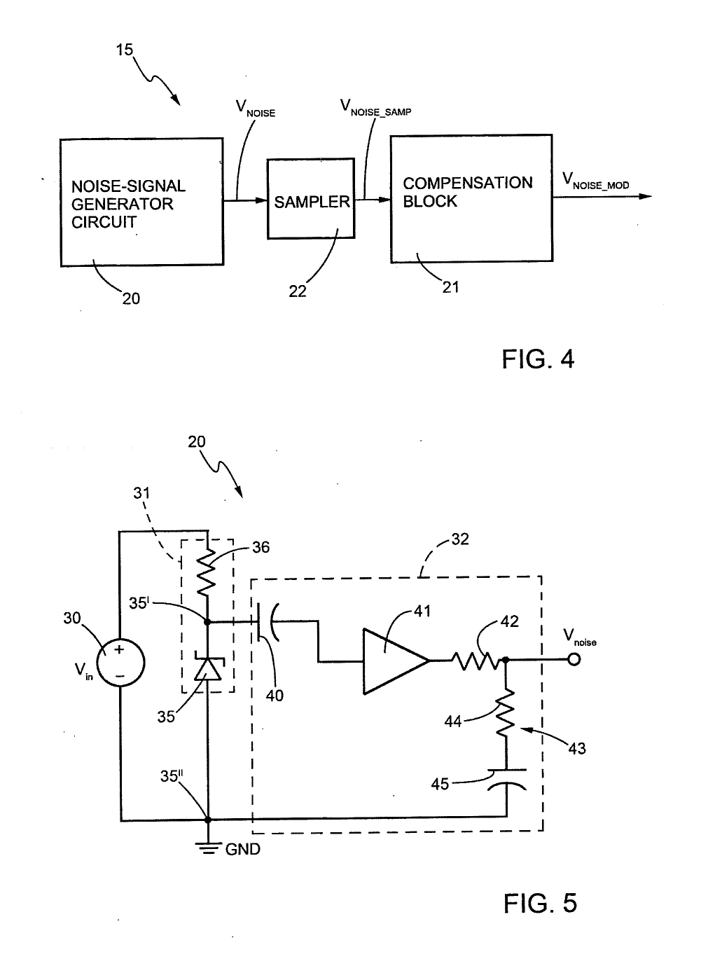

In a second embodiment, in order to increase further the randomness of the sequences of values generated, each period value T_{VAR} is generated by an electronic random-number generator, of a hardware type, illustrated in FIGS. 4 and 5 and described in greater detail in what follows with reference to said figures. According to this embodiment, each random value is generated depending upon physical and operative characteristics of the components that make up the electronic random-number generator. In fact, each random value generated is a function of a plurality of mutually uncorrelated factors, in particular microscopic phenomena, such as for example thermal noise, the level of doping of the electronic components, or other quantum phenomena. An electronic random-number generator of this type is an excellent source of white noise if considered in one or more frequency ranges of interest, in so far as the phenomena on which it is based are, in theory, completely unforeseeable.

It is evident that, according to what has already been described previously, it is expedient also in this case to limit the generation of values in succession within an interval of maximum variation. As described previously, it is possible, for example, to limit the value generated at the (N+1)-th cycle within a range of values comprised between −5% and +5% of the value at the N-th cycle or alternatively configure the control block 13 in such a way that the control block 13 itself controls the inverter circuit 14 with appropriate period values.

FIG. 4 shows a random-signal generator 15 of an electronic type, according to the second embodiment. Here, the random-signal generator 15 comprises a noise-signal generator circuit 20, configured for supplying at one of its outputs a noise signal V_{NOISE} (in this case, a noise voltage of a white type, at least over a limited frequency range). A way for generating random values having non-deterministic statistical properties, envisages the use of a Zener diode. In fact, if a Zener diode is reversely biased at the Zener voltage (i.e., the knee voltage of the avalanche-generation region of the current-voltage characteristic curve), it generates a noise-current signal I_{ZENER} having a behaviour similar to that of a superposition of a fixed mean value to a current white noise (also in this case, the noise is understood as being of a white type at least in a certain limited frequency range). The noise-current signal I_{ZENER} generated by the Zener diode can then be amplified and filtered to generate the noise signal V_{NOISE}.

The random-signal generator 15 further comprises a sampler 22, of a known type, connected to the noise-signal generator circuit 20, and configured for receiving at input the noise signal V_{NOISE}, sampling it, and supplying at output a sampled noise signal V_{NOISE}_{_{—}}_{SAMP}, of a discrete type, thus generating random numerical values, having an own statistical distribution of appearance. In practice, the random numerical values generated in this way have a nonlinear statistical distribution, which is, however, biased around a mean value (or a number of values) depending upon the characteristics of the Zener diode and the biasing voltage of the Zener diode itself.

In the case where it is desired to modify the statistical distribution of the sampled noise signal V_{NOISE}_{_{—}}_{SAMP}, the random-signal generator 15 can advantageously comprise a transformation block 21, having an input connected with the output of the sampler 22 and configured for receiving at input the sampled noise signal V_{NOISE}_{_{—}}_{SAMP}, processing it, and supplying at output a modelled noise signal V_{NOISE}_{_{—}}_{MOD}, formed by discrete values or samples, having statistical distribution more similar to that of a white noise if considered in the frequency range of interest, and having a statistical distribution different from that of the samples of the sampled noise signal V_{NOISE}_{_{—}}_{SAMP}. Each sample of the modelled noise signal V_{NOISE}_{_{—}}_{MOD} is a valid period value T_{VAR} (but for further limitations to contain subsequent period values within a variation of ±5% with respect to the previous value) and can be sent to the sampler device 12.

FIG. 5 shows a possible embodiment of a noise-signal generator circuit 20. The noise-signal generator circuit 20 comprises a biasing circuit (here represented schematically as a generic power supply 30), a noise source 31, and a filtering block 32.

The power supply 30 generates a biasing voltage Vin for biasing the noise source 31. In this case, the noise source 31 comprises a Zener diode 35 and a resistor 36, connected to one another in series. In particular, the Zener diode comprises a first pin 35′, connected to the positive pole of the power supply 30 via the resistor 36, and a second pin 35″, connected to the negative pole of the power supply 30 and to a ground potential line GND. When the power supply 30 biases the Zener diode 35 so as to bring it into conduction in the knee zone of the avalanche-generation region, the Zener diode 35 conducts a noise-current signal I_{ZENER} having a behaviour similar to that of white noise in a certain frequency range. The noise-current signal I_{ZENER} is then supplied to the filtering block 32. The filtering block 32 comprises a capacitor 40, having a first pin and a second pin, the first pin of the capacitor 40 being connected to the first pin 35′ of the Zener diode 35; an amplifier 41, having an input connected to the second pin of the capacitor 40; a resistor 42, connected to an output of the amplifier 41 in series with the amplifier 41; and a low-pass filter 43 (including a resistor 44 and a capacitor 45), connected between the output of the resistor 42 and the ground potential line GND.

Since the noise-current signal I_{ZENER} has both a component of white noise, which is random, and a d.c. component, the capacitor 40 has the function of receiving at input the noise-current signal I_{ZENER} generated by the Zener diode 35 and supplying at output a signal deprived of the d.c. component. Said signal without the d.c. component is then amplified by means of the amplifier 41 and filtered by means of the low-pass filter 43 for supplying at output to the noise-signal generator circuit 20 the noise signal V_{NOISE}. The resistor 42 has the function of uncoupling the noise-signal generator circuit 20 from its load.

To return to FIG. 4, the noise signal V_{NOISE} generated by means of the noise-signal generator circuit 20 of FIG. 5 is then supplied at input to the sampler 22, which in turn generates the sampled noise signal V_{NOISE}_{_{—}}_{SAMP} that is supplied at input to the transformation block 21. The transformation block 21 is configured for modelling the statistical distribution of the sampled noise signal V_{NOISE}_{_{—}}_{SAMP} so as to supply at output the modelled noise signal V_{NOISE}_{_{—}}_{MOD} having a certain statistical distribution, for example linear or else centred on one or more values, or of another type still. As already said, the statistical distribution of the values of period T_{VAR} generated by the random-signal generator 15 can be of various types according to the design choices, the specific application, or the type of inverter used.

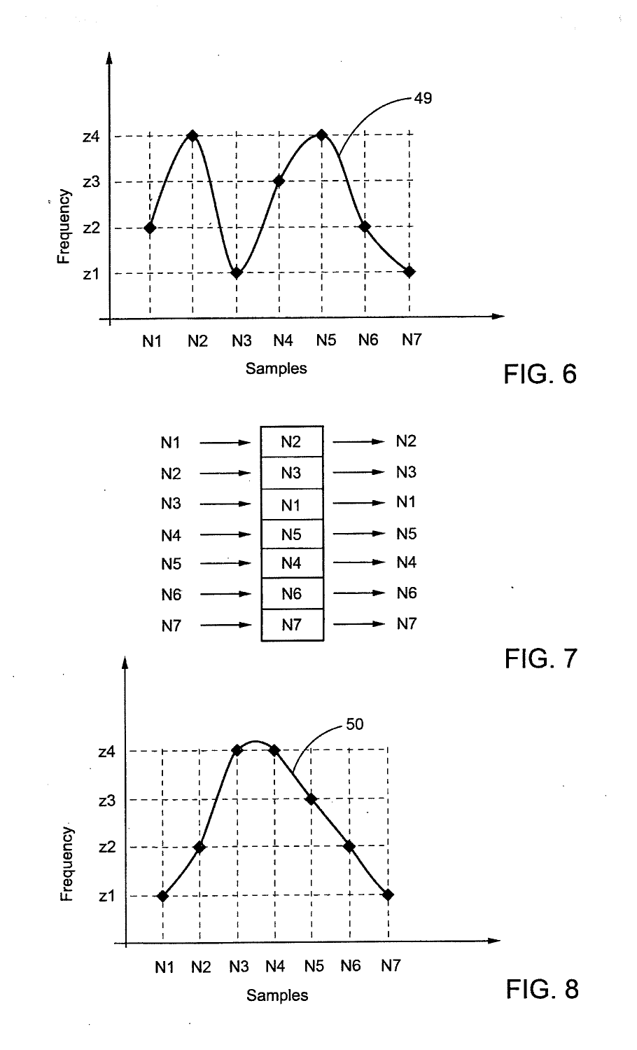

As described hereinafter with reference to FIGS. 6-8, the transformation block 21 implements a function of transformation such as to vary appropriately the statistical distribution of the samples of the sampled noise signal V_{NOISE}_{_{—}}_{SAMP} and generate the modelled noise signal V_{NOISE}_{_{—}}_{MOD} having a different statistical distribution function of its own samples.

FIG. 6 shows by way of example a statistical distribution 49 of samples N1-N7 of the sampled noise signal V_{NOISE}_{_{—}}_{SAMP}. In the example illustrated, the sample N1 presents with a frequency equal to z1, the sample N2 presents with a frequency equal to z4, the sample N3 with a frequency equal to z1, the sample N4 with a frequency equal to z3, etc.

FIG. 7 shows a look-up table 55 that can be used to vary the frequency with which each sample appears, transforming the statistical distribution 49 into the statistical distribution 50 (illustrated in FIG. 8). According to the look-up table illustrated, a sample N1 at input to the look-up table 55 addresses the first field of the look-up table 55, which supplies at output the sample N2; a sample N2 at input to the look-up table 55 addresses the second field of the look-up table 55, which supplies in this case at output the sample N3, etc. In this way, associated to the sample N2 is a frequency of appearance equal to that of the sample N1 (z2 according to the statistical distribution 49); associated to the sample N3 is a frequency of appearance equal to that of the sample N2 (z4 according to the statistical distribution 49); etc.

FIG. 8 shows a possible transformed statistical distribution function 50 (obtained by transforming the curve of statistical distribution 49 on the basis of the look-up table 55 of FIG. 7), in order to increase, in the example illustrated in FIG. 8, the probability for generating the samples at N3 and N4. Since, in general, different Zener diodes have different characteristic curves, different noise-signal generator circuits 20 possess different statistical distributions 49. Consequently, it is advisable to define the type of transformation of the transformed statistical distribution function 50 on the basis of the effective statistical distribution 49 that it is desired to compensate. The statistical distribution 49 can be easily detected experimentally during construction of the random-signal generator 15 by generating a plurality of random values and observing their statistical distribution.

The transformation block 21 can hence be implemented by a mapping structure, for example a look-up table, configured to receive at input samples of the sampled noise signal V_{NOISE}_{_{—}}_{SAMP} and supply at output samples that form the modelled noise signal V_{NOISE}_{_{—}}_{MOD}, having transformed statistical distribution. Each field of the look-up table is associated to a mapping value, in such a way that to each sample of the sampled noise signal V_{NOISE}_{_{—}}_{SAMP} at input to the look-up table there corresponds a respective mapping value of the modelled noise signal V_{NOISE}_{_{—}}_{MOD} at output from the look-up table. In this way, the look-up table supplies at output a mapping value (i.e., a sample of the modelled noise signal V_{NOISE}_{_{—}}_{MOD}) associated to the field addressed by a respective value of the sampled noise signal V_{NOISE}_{_{—}}_{SAMP}.

It is clear that other mapping structures can be used, according to the choices of the designer. Likewise, the choice of the type of statistical distribution of the modelled noise signal V_{NOISE}_{_{—}}_{MOD} can vary according to the choices of the designer. For example, it is possible to define a transformed statistical distribution function 50 designed to concentrate the statistical distribution of the sampled noise signal V_{NOISE}_{_{—}}_{SAMP} around a mean value, corresponding, according to what has been described previously, to a mean value of switching frequencies used for operating the inverter. Said value can for example be decided in the design stage to prevent generation of sounds at audible frequencies or ones that can cause interference with particular systems or apparatuses present in the environment, and in such a way that the switch operates in the operating frequency range proper thereto.

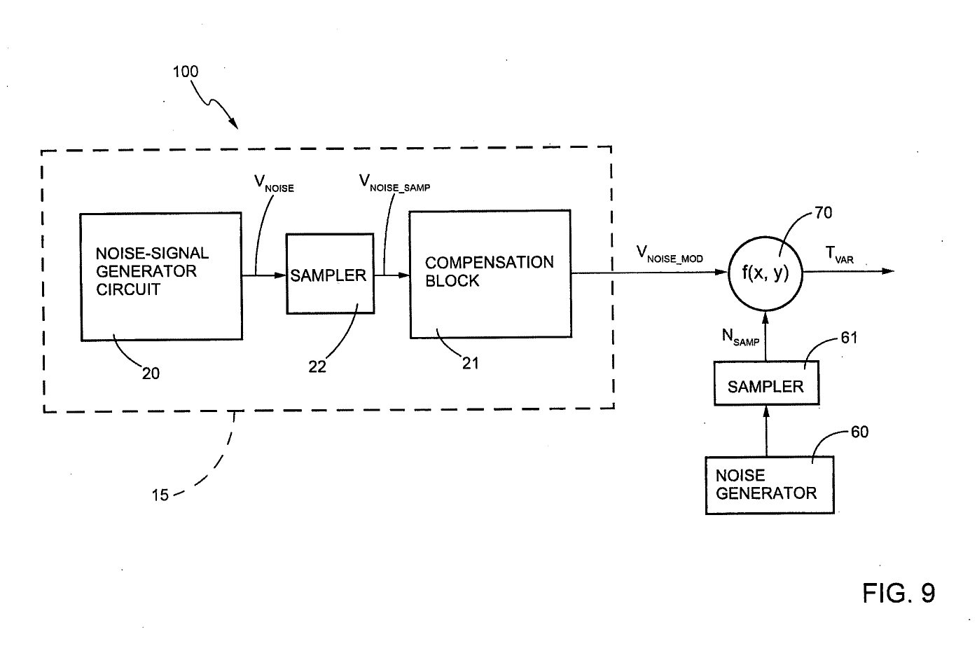

According to a further embodiment illustrated in FIG. 9, it is possible to increase further the randomness of the samples of the modelled noise signal V_{NOISE}_{_{—}}_{MOD} in order, for example, to mask a distinctive modulation of the switching frequencies of the inverter. This becomes useful, for example, in applications in which it is desired to eliminate components of acoustic signature characteristic of the inverter, for example because the components in frequency of the acoustic signature of the inverter can disturb concomitant analyses or interfere with them. For example, studies are known aimed at identifying and classifying marine mammals on the basis of the acoustic signature thereof (or marine fauna in general). A spectral analysis of a large quantity of acoustic signals detected in the sea enables identification of the characteristics present in the power spectral density (band, central frequency, shape of the spectrum, etc.) of the acoustic signals produced by marine mammals and then, on the basis of said characteristics, of classifying the source that has produced the sound as belonging to a given class or species on the basis of said characteristics. It is evident that for said purpose it is necessary to extract from the acoustic signal detected only the signal useful for classification and eliminate a plurality of signals of disturbance that are generally superimposed on the useful signal. For said purpose, repetitive signal components are sought, typical of an acoustic signature. It is evident that in said application the acoustic signature of the inverter (which is not known a priori, can vary according to the switching frequency used, and has an acoustic signature of its own) can be an important element of disturbance in identification of the useful signal.

To reduce further the signature component characteristic of the inverter, FIG. 9 shows an embodiment of a random-signal generator 100 comprising the noise-signal generator circuit 20, the sampler 22, and the transformation block 21 (as illustrated in FIG. 4 and described with reference to the same figure), and moreover comprising a further noise generator 60, a sampler 61, connected to the output of the noise generator 60, and a computation block 70.

In greater detail, the modelled noise signal V_{NOISE}_{_{—}}_{MOD} (constituted, as has been said, by discrete values or samples) generated by the transformation block 21 is supplied at input to the computation block 70. The computation block 70 moreover receives at input noise-signal samples N_{SAMP} generated by the sampler 61 by sampling a noise signal generated by the noise generator 60.

The noise generator 60 can be similar to the noise-signal generator circuit 20, illustrated in FIG. 5 and described with reference to the same figure. Alternatively, the noise-signal samples N_{SAMP} can be generated by means of a generator of random or pseudo-random numbers of a software type (not illustrated). In this case, the sampler 61 is not necessary.

The computation block 70 processes the noise-signal samples N_{SAMP} and the modelled noise signal V_{NOISE}_{_{—}}_{MOD} for supplying at output period values T_{VAR}, more uncorrelated to one another with respect to the samples of the modelled noise signal V_{NOISE}_{_{—}}_{MOD}. In this way, the component of randomness of each sample generated is considerably improved. For example, the computation block 70 can implement a function of addition, subtraction, multiplication, or a generic function f(x,y), where x is a sample of the modelled noise signal V_{NOISE}_{_{—}}_{MOD} and y is a noise sample N_{SAMP}, or vice versa.

From an examination of the characteristics of the driving device obtained according to the present invention the advantages that may be achieved thereby are evident.

In particular, the driving device described enables abatement and masking of spurious components of the frequency spectrum of the supply current/voltage of generic electrical apparatuses (for example, transformers, electric motors, etc.) that can cause a dispersion of acoustic or radiofrequency energy that is not useful to the apparatus in which the driving device is implemented and is able to generate interference with other systems. For example, the driving device enables distribution of the distinctive spectral lines generated by the switching of the switches of the inverter over a wide frequency band so as to simulate a behaviour similar to that of white noise. In this way, moreover, each distinctive spectral line inevitably has a lower specific energy since it is spread over a wider frequency range, thus enabling not only a drastic reduction in the generation of disturbance of an acoustic type and of electromagnetic interference (EMI/EMC) in the surrounding environment, but also an abatement of the acoustic emissions generated both at sound and at ultrasound frequencies.

Finally, the driving device described can be implemented for driving indifferently low-power and high-power motors (for example, ones above or below 150 kW) enabling, in the application of random generation of the switching frequency, maintenance of the control of the current induced in the load even with electrical loads of the inverter characterized by low values of the inductive components, as in the case of drive motors of an APFM type.

Finally, it is clear that modifications and variations may be made to the driving device described and illustrated herein, without thereby departing from the sphere of protection of the present invention, as defined in the annexed claims.

For example, the noise-signal generator circuit can be of a type different from the one described. For example the Zener diode can be replaced by a photodiode that exploits the photoelectric effect, or by a generic electronic device (for example metal or carbon) designed to supply at output a random electrical noise signal correlated to the conduction noise or to other effects linked to quantum phenomena.

In addition, the driving device according to the present invention can be used in generic multiphase electric motors.

Finally, it is clear that the driving device according to the present invention can also be applied to generic electrical generators or generic electric machines.

1. A driving device for an electric machine, comprising:
a converter circuit configured to convert a direct-current supply signal into an alternating-current supply signal;
a control block, connected to the converter circuit and configured to control the converter circuit by means of pulse width modulation, having a cycle time value,
characterized in that it further comprises a first random number generator, connected to the control block and configured to supply the control block with pseudorandom or random cycle time values.

2. The driving device according to claim 1, wherein the converter circuit and the control block form a converter device configured to drive a multiphase electric motor, preferably a three-phase electric motor.

3. The driving device according to claim 1, wherein the converter circuit comprises a plurality of branches, each branch including two electronic switches arranged in series with each other and two diodes, each diode being arranged in parallel with a respective electronic switch, each branch of said plurality of branches being connected in parallel with the other branches of said plurality of branches and with a power supply generating the direct-current supply signal, each branch being configured to supply a respective phase of the alternating-current power signal.

4. The driving device according to claim 3, wherein the control block controls the switching of the electronic switches of the plurality of branches of the converter circuit by means of pulse width modulation.

5. The driving device according to claim 1, wherein the first random number generator is a software-based generator adapted to generate a plurality of pseudorandom or random numbers having an own statistical distribution function.

6. The driving device according to claim 1, wherein the first random number generator comprises a random signal generation block configured to be operated to generate a first random electrical noise signal.

7. The driving device according to claim 6, wherein said random signal generation block comprises a Zener diode configured to be operated at the Zener voltage in the avalanche operation region and generate a noise current signal correlated to the first noise signal.

8. The driving device according to claim 6, wherein the first random number generator further comprises a first sampler, having its own input connected to an output of the random signal generation block, said first sampler being configured to receive the first noise signal in input and generate a first discrete noise signal in output.

9. The driving device according to claim 6, wherein the first noise signal has an own statistical distribution function, the first random number generator further comprising a transformation block, connected to the output of the first sampler and configured to generate a noise signal with modified statistical distribution, having an own statistical distribution function different from the statistical distribution function of the first discrete noise signal.

10. The driving device according to claim 9, further comprising a software-based second random number generator configured to generate a second discrete noise signal in output.

11. The driving device according to claim 9, further comprising a hardware-based second random number generator configured to generate a second electrical noise signal and a second sampler, connected to the second random number generator and configured to receive the second noise signal in input and generate a second discrete noise signal in output.

12. The driving device according to claim 10, further comprising a computation block, connected to the second sampler and to the transformation block, and configured to receive the noise signal with modified statistical distribution and the second discrete noise signal in input and generate said pseudorandom or random cycle time values in output, based on said noise signal with modified statistical distribution and said second discrete noise signal.

13. The driving device according to claim 1, wherein the electric machine is a synchronous, multiphase, axial-flux permanent-magnet electric motor or a generator.

14. A driving method for an electric machine, comprising the steps of:
operating a converter device using a pulse width modulation;
generating an alternating-current supply signal by means of the converter device controlled by the pulse width modulation,
characterized in that it further comprises the steps of:
generating random or pseudorandom cycle time values of the pulse width modulation by means of a first random number generator; and
supplying the random or pseudorandom cycle time values to the converter device.

15. The method according to claim 14, wherein the step of generating pseudorandom values comprises generating pseudorandom numbers by means of a software-based generator.

16. The method according to claim 14, wherein the step of generating random values comprises generating a noise signal by means of a hardware-based generator.

17. The method according to claim 16, wherein the step of generating a noise signal comprises operating an electronic device so as to generate a random electrical noise signal.

18. The method according to claim 17, wherein said electronic device is a Zener diode and said step of operating said electronic device comprises reverse biasing the Zener diode at the Zener voltage.

19. The method according to claim 16, further comprising the step of sampling the noise signal to generate a sampled noise signal.

20. The method according to claim 19, wherein the sampled noise signal has an own statistical distribution function, the method further comprising the step of generating a noise signal with modified statistical distribution having an own statistical distribution function, different from that of the statistical distribution function of the sampled noise signal.

21. The method according to claim 20, wherein the step of generating a noise signal with modified statistical distribution comprises creating a correspondence between one or more samples of the sampled noise signal and a respective sample of the noise signal with modified statistical distribution.

22. The method according to claim 14, wherein the electric machine is a synchronous, multiphase, axial-flux, permanent-magnet electric motor or a generator.
